(19) United States
(12) Patent Application Publication
(10) Pub. No.: US 2025/0002766 A1
(43) Pub. Date: Jan. 2, 2025

(54) DUAL CURE ADHESIVE COMPOSITION

(71) Applicant: MOMENTIVE PERFORMANCE MATERIALS INC., Niskayuna, NY (US)

(72) Inventors: Anne Dussaud, Tarrytown, NY (US); Michael Youngberg, Westwood, NJ (US)

(21) Appl. No.: 18/755,806

(22) Filed: Jun. 27, 2024

Related U.S. Application Data
(60) Provisional application No. 63/524,365, filed on Jun. 30, 2023.

(51) Int. Cl. C09J 175/04; C09J 5/06; C09J 7/10; C09J 11/06

(52) U.S. Cl. CPC C09J 175/04; C09J 5/06; C09J 7/10; C09J 11/06; C09J 2301/312; C09J 2301/408; C09J 2301/50; C09J 2400/163

(57) ABSTRACT

An adhesive composition is shown and described herein. The composition comprises a silylated polyurethane, an epoxy functional compound, and an amine functional compound. The compositions are provided to control the molar ratio of amine active hydrogen (AH) to epoxy (E) groups. By controlling the amine active hydrogen to epoxy molar ratio, an adhesive with excellent adhesion and strength on a variety of types of substrates is provided.

### CROSS-REFERENCE TO RELATED APPLICATIONS

This application claims priority to and the benefit of U.S. Provisional Application 63/524,365 titled “DUAL CURE ADHESIVE COMPOSITION” filed on Jun. 30, 2023, the disclosure of which is incorporated herein by reference in its entirety.

### FIELD OF INVENTION

The present invention relates to an adhesive composition. In particular, the present invention relates to a dual cure adhesive composition comprising a silylated polyurethane, an amine functional compound, and an epoxy functional compound. The compositions exhibit high adhesion on substrates and high adhesion to substrates of different materials or classes of materials.

### BACKGROUND

Silylated moisture curable resins have broad application as adhesive materials for use in a wide variety of applications. Such adhesives may be used in, for example, construction, transportation, and/or electronic applications to name a few. Silylated polyurethanes (SPUR) can provide an isocyanate-free alternative to polyurethane resins. Isocyanates potentially create toxicity issues in some applications.

While providing an isocyanate-free alternative to polyurethanes, silylated polyurethanes may still not be a viable solution for many applications. For example, silylated polyurethanes may not exhibit suitable bonding strengths that may be necessary for many applications. Further, silylated polyurethanes may not exhibit sufficient bonding across a wide range of substrate types.

Two-part polyurethane adhesives are a potential solution to provide an adhesive with the desired elasticity and strength requirements for the desired applications. Such adhesives, however, typically require the use of primers. The primers for such materials are often isocyanate-based primers, which does not achieve the goal of reducing or eliminating isocyanate from the adhesive composition.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is an adhesive composition. The composition comprises a silylated polyurethane, an epoxy functional compound, and an amine functional compound. The compositions are provided to control the molar ratio of amine active hydrogen (AH) to epoxy (E) groups. By controlling the amine active hydrogen to epoxy molar ratio, an adhesive with excellent adhesion and strength on a variety of types of substrates is provided.

In one aspect, provided is a composition comprising: a silylated polyurethane; an amine functional compound; and an epoxy functional compound; wherein the composition has a molar ratio of amine active hydrogen to epoxy of in a range from about 0.3 to less than 0.8.

In one embodiment, the composition has a molar ratio of amine active hydrogen to epoxy from about 0.3 to about 0.75.

In one embodiment, the composition has a molar ratio of amine active hydrogen to epoxy of in a range from about 0.4 to about 0.7.

In one embodiment, the composition has a molar ratio of amine active hydrogen to epoxy of from about 0.5 to about 0.6.

In one embodiment in accordance with any of the previous embodiments, the amine functional compound is selected from a polyether amine, an amino silane, or a combination thereof.

In one embodiment, the polyether amine has a weight average molecular weight of from about 150 to about 6000.

In one embodiment in accordance with any of the previous embodiments, the composition comprises the polyether amine in an amount of from about 0.1 wt. % to about 10 wt. %, and the amino silane in an amount of from about 0.1 wt. % to about 10 wt. % based on the total weight of the composition.

In one embodiment in accordance with any of the previous embodiments, the amino silane is selected from a compound of the formula:

(R¹¹)(R¹²)N—R¹³—Si(OR¹⁴)₃₋ₕ(R¹⁵)ₕ;

R¹⁶—NH—R¹⁷—Si(OR¹⁸)₃₋ᵢ(R¹⁹)i;

(R²⁰)ⱼ(R²¹O)₃₋ⱼSi—R²²—NH—R²³—Si(OR²⁴)₃₋ₖ(R²⁵)k;

N—(R²⁶—Si(OR²⁷)₃₋ₘ(R²⁸m)₃;

where R¹¹, R¹², and R¹⁶ are independently selected from H or a monovalent C1-C20 hydrocarbon; R¹⁴, R¹⁵, R¹⁸, R¹⁹, R²⁰, R²¹, R²⁴, R²¹, R²⁷, and R²⁸ are independently selected from a C1-C20 monovalent hydrocarbon; R¹³, R¹⁷, R²², and R²⁶ are independently selected from a divalent C1-C20 hydrocarbon; h, i, j, k, and m are independently selected from 0-2.

In one embodiment in accordance with any of the previous embodiments, the composition further comprises an additive selected from pigments, fillers, curing catalysts, dyes, plasticizers, thickeners, coupling agents, extenders, volatile organic solvents, wetting agents, tackifiers, crosslinking agents, thermoplastic polymers, moisture scavengers, and UV stabilizers.

In one embodiment, the catalyst is a Tin catalyst.

In one embodiment in accordance with any of the previous embodiments, the filler is selected from organic fillers, inorganic fillers, conductive fillers, or combinations thereof.

In one embodiment in accordance with any of the previous embodiments, the conductive filler is a thermally conductive filler selected from alumina, magnesia, ceria, hafnia, lanthanum oxide, neodymium oxide, samaria, praseodymium oxide, thoria, urania, yttria, zinc oxide, zirconia, silicon aluminum oxynitride, borosilicate glasses, barium titanate, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, aluminum hydroxide, magnesium hydroxide, silica, silicon dioxide, titanium dioxide, glass fibers, glass flake, clays, exfoliated clays, or other high aspect ratio fibers, rods, or flakes, calcium carbonate, zinc oxide, magnesia, titania, calcium carbonate, talc, mica, wollastonite, alumina, aluminum nitride, graphite, graphene, aluminum powder, copper powder, bronze powder, brass powder, fibers or whiskers of carbon, graphite, silicon carbide, silicon nitride, alumina, aluminum nitride, zinc oxide, carbon nanotubes, boron nitride nanosheets, zinc oxide nanotubes, or a combination of two or more thereof.

In another aspect, provided is a composition comprising a first part and a second part, wherein the first part comprises (i) a silylated polyurethane and an amino functional compound, and the second part comprises (ii) an epoxy functional compound.

In yet another aspect, provided is a method of forming an adhesive comprising: (i) exposing the composition of any of any of the previous embodiments; and subsequently (ii) curing the composition to a temperature of from about 50° C. to about 130° C.

In one embodiment, the adhesive is formed on a substrate.

In still another aspect, provided is a method of bonding two substrates comprising: applying the composition of any of the previous embodiments on a first substrate; contacting a second substrate with the composition applied on the first substrate; and curing the composition at a temperature of from about 50° C. to about 130° C.

In one embodiment, first and second substrate are each independently of a type selected from a metal, a thermoplastic, a thermoset, a glass, a carbon substrate, a ceramic, cement, and wood.

In one embodiment in accordance with any of the previous embodiments, the first substrate and the second substrate are the same type of material.

In one embodiment in accordance with any of the previous embodiments, the first substrate is a thermoplastic substrate, and the second substrate is a metal substrate.

In one embodiment in accordance with any of the previous embodiments, the first and second substrate are each free of a primer coating.

In a further aspect, provided is an article comprising a first substrate bonded to a second substrate with an adhesive formed from the composition of any of the previous embodiments.

In one embodiment, the first and second substrates are each independently of a type selected from a metal, a thermoplastic, a thermoset, a glass, a carbonaceous substrate, a ceramic, cement, wood, and combinations of two or more thereof.

In one embodiment in accordance with any of the previous embodiments, the first substrate and the second substrate are the same type of material.

In one embodiment in accordance with any of the previous embodiments, the first substrate is a thermoplastic substrate, and the second substrate is a metal substrate.

In one embodiment in accordance with any of the previous embodiments, wherein the first and second substrate are each free of a primer coating.

In one embodiment in accordance with any of the previous embodiments, the article has a shear strength of about 3 MPa or greater as determined via ASTM D1002.

In one embodiment in accordance with any of the previous embodiments, the article delaminates cohesively as determined via ASTM D1002.

In one embodiment in accordance with any of the previous embodiments, the article delaminates cohesively as determined via ASTM D1002 after curing for 24 hours at 50° C. followed by immersion in 50° C. water for one week.

In one embodiment in accordance with any of the previous embodiments, the article has a shear strength of about 4 MPa or greater when measured after immersion in 50° C. water for one week, as determined via ASTM D1002.

In one embodiment in accordance with any of the previous embodiments, the article has a shear strength of about 10 MPa or greater when measured after immersion in 50° C. water for one week, as determined via ASTM D1002.

The following description discloses various illustrative aspects. Some improvements and novel aspects may be expressly identified, while others may be apparent from the description.

The following description discloses various illustrative aspects. Some improvements and novel aspects may be expressly identified, while others may be apparent from the description.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Ranges for a particular category of material or parameters can be combined to form new and non-specified ranges.

Provided is an adhesive composition. The composition comprises a silylated polyurethane, an epoxy functional compound, and an amine functional compound. The compositions are provided to control the molar ratio of amine active hydrogen to epoxy groups. By controlling the amine active hydrogen to epoxy molar ratio, an adhesive with excellent adhesion and strength on a variety of types of substrates is provided. The composition provides adhesion to various substrates under different conditions, such as adhesion under dry conditions and/or wet conditions.

### Silylated Polyurethane

The silylated polyurethane is not particularly limited and generally comprises a polyurethane that has been functionalized with a silane group. The silylated polyurethane can be formed by reacting an isocyanate terminated polyurethane (PUR) prepolymer or a hydroxy terminated polyurethane prepolymer with a silane having an appropriate functional group to react with the isocyanate or hydroxy group as may be appropriate to provide the desired silylated polyurethane.

In one embodiment, the moisture-curable resin is a SPUR resin such as, but not limited to, those described in U.S. Pat. No. 5,990,257 and can be made by any of the methods described therein, the entire contents of which are incorporated herein by reference in their entireties.

Isocyanate-terminated PUR prepolymers can be obtained by reacting one or more polyols, such as, but not limited to, diols, with one or more polyisocyanates, such as, but not limited to, diisocyanates, in such proportions that the resulting prepolymers will be terminated with isocyanate. In the case of reacting a diol with a diisocyanate, a molar excess of diisocyanate will be employed.

Included among the polyols that can be utilized for the preparation of the isocyanate-terminated PUR prepolymer are polyether polyols, such as the hydroxyl-terminated polycaprolactones, polyetherester polyols such as those obtained from the reaction of polyether polyol with e-caprolactone, polyesterether polyols such as those obtained from the reaction of hydroxyl-terminated polycaprolactones with one or more alkylene oxides such as ethylene oxide and propylene oxide, hydroxyl-terminated polybutadienes, and the like.

Examples of suitable polyols that can be utilized for the preparation of the isocyanate-terminated PUR prepolymer include, but are not limited to, the poly(oxyalkylene)ether diols (i.e., polyether diols), in particular, the poly(oxyethylene)ether diols, the poly(oxypropylene)ether diols and the poly(oxyethylene-oxypropylene)ether diols, poly(oxyalkylene)ether triols, poly(tetramethylene)ether glycols, polyacetals, polyhydroxy polyacrylates, polyhydroxy polyester amides, polyhydroxy polythioethers, polycaprolactone diols and triols, and the like. In one embodiment, the polyols used in the production of the isocyanate-terminated PUR prepolymers are poly(oxyethylene)ether diols with equivalent weights from about 500 to about 25,000, from about 1,000 to about 20,000, from about 2,500 to about 15,000, or from about 5,000 to about 10,000. Mixtures of polyols of various structures, molecular weights and/or functionalities can also be used.

The polyether polyols can have a functionality up to about 8. In embodiments, the polyether polyols have a functionality of from 2 to 4, and in one embodiment, a functionality of 2 (i.e., diols). Especially suitable are the polyether polyols prepared in the presence of double-metal cyanide (DMC) catalysts, an alkaline metal hydroxide catalyst, or an alkaline metal alkoxide catalyst; see, for example, U.S. Pat. Nos. 3,829,505, 3,941,849, 4,242,490, 4,335,188, 4,687,851, 4,985,491, 5,096,993, 5,100,997, 5,106,874, 5,116,931, 5,136,010, 5,185,420 and 5,266,681, the entire contents of each of the foregoing patents are incorporated herein by reference in their entireties. In one embodiment, the polyether polyols preferably have a number average molecular weight of from about 1,000 to about 25,000, more preferably from about 2,000 to about 20,000, and even more preferably from about 4,000 to about 18,000. Number average molecular weight may be determined using gel permeation chromatography (GPC). Examples of commercially available diols that are suitable for making the isocyanate-terminated PUR prepolymer include ARCOL R-1819 (number average molecular weight of 8,000), E-2204 (number average molecular weight of 4,000), and ARCOL E-2211 (number average molecular weight of 11,000), ACCLAIM 8200 (number average molecular weight of 8000, ACCLAIM 12200 (number molecular weight of 12000), ACCLAIM 18200 (number average molecular weight of 18000).

Any of numerous polyisocyanates, such as, but not limited to, diisocyanates, and mixtures thereof, can be used to provide the isocyanate-terminated PUR prepolymers. In one embodiment, the polyisocyanate can be diphenylmethane diisocyanate (“MDI”), polymethylene polyphenylisocyanate (“PMDI”), paraphenylene diisocyanate, naphthylene diisocyanate, liquid carbodiimide-modified MDI and derivatives thereof, isophorone diisocyanate, dicyclohexylmethane-4,4′-diisocyanate, toluene diisocyanate (“TDI”), particularly the 2,6-TDI isomer, as well as various other aliphatic and aromatic polyisocyanates that are well-established in the art, and combinations thereof.

Silylation reactants for reacting with the isocyanate-terminated PUR prepolymers include functionality that is reactive with isocyanate and at least one readily hydrolyzable and subsequently crosslinkable group, e.g., alkoxy. In one embodiment, the silylation reactants are the silanes of the general formula:

X—R¹—Si(R²)ₓ(OR³)₃₋ₓ

wherein X is an active hydrogen-containing group that is reactive for isocyanate, e.g., —SH or —NHR⁴ in which R⁴ is H, a monovalent hydrocarbon group of up to 8 carbon atoms or −R⁵—Si(R⁶)_{y}(OR⁷)_{3-y}, R¹ and R⁵ each is the same or different divalent hydrocarbon group of up to 12 carbon atoms, optionally containing one or more heteroatoms, each R² and R⁶ is the same or different monovalent hydrocarbon group of up to 8 carbon atoms, each R³ and R⁷ is the same or different alkyl group of up to 6 carbon atoms and x and y each, independently, is 0, 1 or 2.

Examples of silanes that can be used as reactants to silylate a resin include, but are not limited to, the mercaptosilanes 2-mercaptoethyl trimethoxysilane, 3-mercaptopropyl trimethoxysilane, 2-mercaptoethyl triethoxysilane, 3-mercaptopropyl triethoxysilane, 2-mercaptoethyl tripropoxysilane, 2-mercaptoethyl tri sec-butoxysilane, 3-mercaptopropyl tri-t-butoxysilane, 3-mercaptopropyl triisopropoxysilane, 3-mercaptopropyl trioctoxysilane, 2-mercaptoethyl tri-2′-ethylhexoxysilane, 2-mercaptoethyl dimethoxy ethoxysilane, 3-mercaptopropyl methoxyethoxypropoxysilane, 3-mercaptopropyl dimethoxy methylsilane, 3-mercaptopropyl methoxy dimethylsilane, 3-mercaptopropyl ethoxy dimethylsilane, 3-mercaptopropyl diethoxy methylsilane, 3-mercaptopropyl cyclohexoxy dimethyl silane, 4-mercaptobutyl trimethoxysilane, 3-mercapto-3-methylpropyltrimethoxysilane, 3-mercapto-3-methylpropyl-tripropoxysilane, 3-mercapto-3-ethylpropyl-dimethoxy methylsilane, 3-mercapto-2-methylpropyl trimethoxysilane, 3-mercapto-2-methylpropyl dimethoxyphenylsilane, 3-mercaptocyclohexyl-trimethoxysilane, 12-mercaptododecyl trimethoxy silane, 12-mercaptododecyl-triethoxy silane, 18-mercaptooctadecyl trimethoxysilane, 18-mercaptooctadecyl methoxydimethylsilane, 2-mercapto-2-methylethyl-tripropoxysilane, 2-mercapto-2-methylethyl-trioctoxysilane, 2-mercaptophenyl trimethoxysilane, 2-mercaptophenyl triethoxysilane, 2-mercaptotolyl trimethoxysilane, 2-mercaptotolyl triethoxysilane, 1-mercaptomethyltolyl trimethoxysilane, 1-mercaptomethyltolyl triethoxysilane, 2-mercaptoethylphenyl trimethoxysilane, 2-mercaptoethyiphenyl triethoxysilane, 2-mercaptoethyltolyl trimethoxysilane, 2-mercaptoethyltolyl triethoxysilane, 3-mercaptopropylphenyl trimethoxysilane and, 3-mercaptopropylphenyl triethoxysilane, and the aminosilanes 3-aminopropyltrimethoxysilane, 3-aminopropyltriethoxysilane, 4-aminobutyltriethoxysilane, N-methyl-3-amino-2-methylpropyltrimethoxysilane, N-ethyl-3-amino-2-methylpropyltrimethoxysilane, N-ethyl-3-amino-2-methylpropyldiethoxymethylsilane, N-ethyl-3-amino-2-methylpropyltriethoxysilane, N-ethyl-3-amino-2-methylpropylmethyldimethoxysilane, N-butyl-3-amino-2-methylpropyltrimethoxysilane, 3-(N-methyl-2-amino-1-methyl-1-ethoxy)-propyltrimethoxysilane, N-ethyl-4-amino-3,3-dimethyl-butyldimethoxymethylsilane, N-ethyl-4-amino-3,3-dimethylbutyltrimethoxy-silane, N-(cyctohexyl)-3-aminopropyltrimethoxysilane, N-(2-aminoethyl)-3-aminopropyitrimethoxysilane, N-(2-aminoethyl)-3-aminopropyltriethoxysilane, N-(2-aminoethyl)-3-aminopropylmethyldimethoxysilane, aminopropyltriethoxysilane, bis-(3-trimethoxysilyl-2-methylpropyl)amine and N-(3′-trimethoxysilylpropyl)-3-amino-2-methylpropyltrimethoxysilane.

A catalyst will ordinarily be used to prepare the isocyanate-terminated PUR prepolymers. Condensation catalysts are generally employed to prepare the PUR. These catalysts may also catalyze the cure (hydrolysis followed by crosslinking) of the SPUR resin component of the moisture-curable composition. Suitable condensation catalysts include, but are not limited to, the dialkyltin dicarboxylates such as dibutyltin dilaurate and dibutyltin acetate, tertiary amines, the stannous salts of carboxylic acids, such as stannous octoate and stannous acetate, and the like. In one embodiment of the present invention, dibutyltin dilaurate catalyst is used in the production of the PUR prepolymer. Other useful catalysts include titanium-containing, zirconium-containing and bismuth-containing complexes such as K-KAT® XC6212, K-KAT® XC-A209 and K-KAT® 348, supplied by King Industries, Inc., aluminum chelates such as the TYZOR® types, available from Dorf Ketal company, and the KR types, available from Kenrich Petrochemical, Inc., and other organometallic catalysts, e.g., those containing a metal such as Zn, Co, Ni, Fe, and the like.

In another embodiment, moisture-curable SPUR resins can be obtained from a hydroxyl-terminated PUR prepolymer. A moisture-curable SPUR resin can, as previously indicated, be prepared by reacting a hydroxyl-terminated PUR prepolymer with an isocyanatosilane. The hydroxyl-terminated PUR prepolymer can be obtained in substantially the same manner employing substantially the same materials, i.e., polyols, polyisocyanates and optional catalysts (e.g., condensation catalysts), described above for the preparation of isocyanate-terminated PUR prepolymers. The one major difference in these reactions is that the polyol and polyisocyanate are provided in a ratio that will result in hydroxyl-termination in the resulting prepolymer. Thus, e.g., in the case of a diol and a diisocyanate, a molar excess of the former will be used thereby resulting in hydroxyl-terminated PUR prepolymer.

Useful silylation reactants for the hydroxyl-terminated SPUR resins are those containing isocyanate termination and readily hydrolyzable functionality, e.g., 1 to 3 alkoxy groups. Suitable silylating reactants are the isocyanatosilanes of the general formula:

OCN—R⁸—Si(R⁹)ₓ(OR¹⁰)₃₋ₓ

wherein R⁸ is an alkylene group of up to 12 carbon atoms, optionally containing one or more heteroatoms, each R⁹ is the same or different alkyl or aryl group of up to 8 carbon atoms, each R¹⁰ is the same or different alkyl group of up to 6 carbon atoms and x is 0, 1 or 2. In one embodiment, R¹ possesses 1 to 4 carbon atoms, each R¹⁰ is the same or different methyl, ethyl, propyl or isopropyl group and x is 0.

Specific isocyanatosilanes that can be used to react with hydroxyl-terminated PUR prepolymers to provide moisture-curable SPUR resins include, but are not limited to, isocyanatopropyltrimethoxysilane, isocyanatoisopropyltrimethoxysilane, isocyanato-n-butyltrimethoxysilane, isocyanato-t-butyltrimethoxysilane, isocyanatopropyltriethoxysilane, isocyanatoisopropyltriethoxysilane, isocyanato-n-butyltriethoxysilane, isocyanato-t-butyltriethoxysilane, and the like.

The polymer may, in various embodiments, have a general formula of:

R^{z}—[OC(O)NH—R⁸Si(R⁹)ₓ(OR¹⁰)₃₋ₓ]_{y}

where R^{z} is an organic polymer fragment, R⁸, R⁹, and R¹⁰ are as described above, and y is 1 to 6. In one embodiment, the organic polymer fragment is a polymer fragment containing at least one urethane group.

Examples of silyl terminated polyurethane oligomers include, but are not limited to, SPUR1010 and SPUR1050 from Momentive Performance Materials, Desmoseal 2458, 2636, 2662, available from Covestro, and the like.

The silylated polyurethane can be present in an amount of from about 3 wt. % to about 70 wt. %, from about 5 wt. % to about 60 wt. %, or from about 10 wt. % to about 50 wt. % based on the total weight of the composition.

### Amine Functional Compounds

The compositions include an amine functional compound. The amine functional compound can be selected as desired. The amine functional compound is provided to have at least one active hydrogen.

The hydrogen content of the amine functional compound may be described in terms of the amine hydrogen weight equivalent (AHEW). As used herein, the AHEW of a molecule may be calculated by dividing its molecular weight by the number of hydrogen atoms that are attached to amino nitrogen atoms in the molecule.

In one embodiment, the amine functional compound can be selected from a compound that functions as an epoxy hardener. The epoxy hardener may be an amine functional compound such as polyamine, like diamine, or a polyamine blend. It will be appreciated that the composition can include a mixture of two or more of such types of compounds.

In one embodiment, the amine functional compound is selected from a polyether amine. The polyether amine can be selected from a primary or secondary amine-terminated polyether. In one embodiment, the polyether amine has at least two amino groups, which may be the same or different. In embodiments each amino group in the polyether amine is a primary amine. In one embodiment, the polyether amine is a primary diamine. The polyether groups in the polyether amine can be selected from any suitable alkylene oxide unit. In embodiments, the polyether amine is a poly(C2-C24 alkylene oxide) with amine functional groups. In embodiments, the polyether groups are selected from ethylene oxide groups, polypropylene oxide groups, or combinations thereof.

In one embodiment, the amine compound is an aliphatic amine or an aromatic amine.

In one embodiment, the polyether amine has a number average molecular weight of from about 150 to about 6000, from about 200 to about 2000, or from about 230 to about 500. Number average molecular weight may be determined using gel permeation chromatography (GPC).

Examples of suitable polyether amines include, but are not limited to, those available under the tradename JEFFAMINE® from the Huntsman Corporation of The Woodlands, Texas.

In one embodiment, the amine functional compound may have AHEWs in the range of 10 to about 300. In particular embodiments, the epoxy hardener has an AHEW in the range of from about 55 to about 65; or from about 75 to about 90; or from about 140 to about 160. Two commercial examples of epoxy hardeners are JEFFAMINE® D-230 amine (AHEW=60) and JEFFAMINE® T-403 amine (AHEW=81). JEFFAMINE® D-230 amine is a diprimary polyetheramine of approximately 230 molecular weight. JEFFAMINE® T-403 amine is a triprimary polyetheramine of approximately 403 molecular weight. Both amines are available from the Huntsman Corporation of The Woodlands, Texas.

The polyether amine can be present in an amount of from about 0.1 wt. % to about 10 wt. %, from about 0.2 wt. % to about 5 wt. %, or from about 0.4 wt. % to about 4 wt. % based on the total weight of the composition.

In another embodiment, the amine functional compound can be selected from an amino silane. The amino silane can be a primary amino silane, a secondary amino silane, a tertiary amino silane, or a mixture of two or more thereof. In one embodiment, the adhesion promoter is selected from at least a secondary amino silane.

In one embodiment, the amino silane is chosen from an aminoalkyltrialkoxysilane, an aminoalkylalkyldialkoxysilane, a bis(alkyltrialkoxysilyl)amine, a tris(alkyltrialkoxysilyl)amine, a tris(alkyltrialkoxysilyl)cyanuarate, and a tris(alkyltrialkoxy-silyl) isocyanuarate, or a combination of two or more thereof.

In one embodiment, the amino silane can be selected from one or more compounds of the formulas:

(R¹¹)(R¹²)N—R¹³—Si(OR¹⁴)₃₋ₕ(R¹⁵)ₕ

R¹⁶—NH—R¹⁷—Si(OR¹⁸)₃₋ᵢ(R¹⁹)i

(R²⁰)ⱼ(R²¹O)₃₋ⱼSi—R²²—NH—R²³—Si(OR²⁴)₃₋ₖ(R²⁵)k

N—(R²⁶—Si(OR²⁷)₃₋ₘ(R²⁸m)₃

where R¹¹, R¹², and R¹⁶ are independently selected from H or a monovalent C1-C20 hydrocarbon; R¹⁴, R¹⁵, R¹⁸, R¹⁹, R²⁰, R²¹, R²⁴, R²⁵, R²⁷, and R²⁸ are independently selected from a C1-C20 monovalent hydrocarbon; R¹³, R¹⁷, R²², and R²⁶ are independently selected from a divalent C1-C20 hydrocarbon; h, i, j, k, and m are independently selected from 0-2. In one embodiment, R¹¹, R¹², R¹⁶, R¹⁴, R¹⁵, R¹⁸, R¹⁹, R²⁰, R²¹, R²⁴, R²⁵, R²⁷, and R²⁸ are selected from a C1-C20 alkyl, a C2-C15 alkyl, a C4-C10 alkyl, or a C6-C8 alkyl. In one embodiment R¹¹, R¹², R¹⁶, R¹⁴, R¹⁵, R¹⁸, R¹⁹, R²⁰, R²¹, R²⁴, R²⁵, R²⁷, and R²⁸ are independently selected from a C1-C4 alkyl. In one embodiment, R¹³, R¹⁷, R²², and R²⁶ are independently selected from a C1-C20 alkylene, a C2-C15 alkylene, a C3-C10 alkylene, or a C4-C8 alkylene.

Examples of suitable amino silanes include, but are not limited to, N-(2-aminoethyl)aminopropyltrimethoxysilane gamma-aminopropyltriethoxysilane, gamma-aminopropyltrimethoxysilane, bis(gamma-trimethoxysilypropyl)amine, N-phenyl-gamma-aminopropyltrimethoxysilane, triaminofunctionaltrimethoxysilane, gamma-aminopropylmethyldimethoxysilane, gamma-aminopropylmethyldiethoxysilane, methyl aminopropyltrimethoxysilane, alpha,omega-bis-(aminoalkyl-diethoxysilyl)-polydimethylsiloxanes, alpha, omega-bis-(aminoalkyl-diethoxysilyl)-octa-methyltetrasiloxane, 4-amino-3,3,-dimethyl-butyl-trimethoxysilane, and N-ethyl-3-tri-methoxy-silyl-2-methylpropanamine, 3-(diethyl-aminopropyl)-trimethoxysilane, 3-aminopropyltrimethoxysilane, 3-aminopropyltriethoxysilane, 3-aminopropyltrismethoxy-ethoxyethoxysilane, 3-aminopropyl-methyl-diethoxysilane, N-methyl-3-aminopropyltrimethoxysilane, N-butyl-3-aminopropyltrimethoxysilane, (N-Gyclohexylaminomethy)methyldi-ethoxysilane, (N-cyclohexylaminomethyl)triethoxysilane, (N-phenylaminomethyl)methyldimethoxysilane, (N-phenylaminomethyl)trimethoxysilane, N-ethyl-aminoisobutyltrimethoxysilane, 4-amino-3,3-dimethylbutyltrimethoxysilane, combinations of two or more thereof, and the like. Oligomeric aminosilanes and amino functional oligosiloxane can be used.

Examples of suitable amino silanes include, but are not limited to, N-(2-aminoethyl)aminopropyltrimethoxysilane gamma-aminopropyltriethoxysilane, gamma-aminopropyltrimethoxysilane, bis(gamma-trimethoxysilypropyl)amine, N-phenyl-gamma-aminopropyltrimethoxysilane, triaminofunctionaltrimethoxysilane, gamma-aminopropylmethyldimethoxysilane, gamma-aminopropylmethyldiethoxysilane, methacryloxypropyltrimethoxysilane, methyl aminopropyltrimethoxysilane, gamma-glycidoxypropylethyldimethoxysilane, gamma-glycidoxypropyltrimethoxysilane, gamma-glycidoxyethyltrimethoxysilane, gamma-(3,4-epoxycyclohexyl)ethyltrimethoxysilane, beta-(3,4-epoxycyclohexyl)ethylmethyl-dimethoxysilane, epoxylimonyltrimethoxysilane, isocyanatopropyltriethoxysilane, isocyanatopropyltrimethoxysilane, isocyanatopropylmethyldimethoxysilane, beta-cyano-ethyl-trimethoxysilane, gamma-acryloxypropyl-trimethoxy-silane, gamma-methacryloxypropyl-methyldimethoxysilane, alpha, omega-bis-(aminoalkyl-diethoxysilyl)-polydimethylsiloxanes, alpha, omega-bis-(aminoalkyl-diethoxysilyl)-octa-methyltetrasiloxane, 4-amino-3,3,-dimethyl-butyl-trimethoxysilane, and N-ethyl-3-tri-methoxy-silyl-2-methylpropanamine, 3-(diethyl-aminopropyl)-trimethoxysilane, 3-aminopropyltrimethoxysilane, 3-aminopropyltriethoxysilane, 3-aminopropyltrismethoxy-ethoxyethoxysilane, 3-aminopropyl-methyl-diethoxysilane, N-methyl-3-aminopropyltrimethoxysilane, N-butyl-3-aminopropyltrimethoxysilane, 3-mercaptopropyltrimethoxysilane, 3-mercaptopropyltriethoxysilane, 3-mercaptopropyl-methyl-dimethoxysilane, (N-Gyclohexylaminomethy)methyldi-ethoxysilane, (N-cyclohexylaminomethyl)triethoxysilane, (N-phenylaminomethyl)methyldimethoxysilane, (N-phenylaminomethyl)trimethoxysilane, N-ethyl-aminoisobutyltrimethoxysilane, 4-amino-3,3-dimethylbutyltrimethoxysilane, combinations of two or more thereof, and the like.

Examples of suitable amino silanes may include, but are not limited to, Silquest® A-1120 silane, Silquest® A-2120 silane, Silquest® A-1170 silane, Silquest A-Link 600, Silquest A-Link 235 silane available from Momentive Performance Materials.

The amino silane can be present in an amount of from about 0.1 wt. % to about 10 wt. %, from about 1 wt. % to about 5 wt. %, or from about 1.5 wt. % to about 4 wt. % based on the total weight of the composition.

### Epoxy Functional Compound

The epoxy functional compound is not particularly limited and can be selected as desired for a particular purpose or intended application. Generally, term “epoxy resin” as used herein refers to a composition or compound that has one or more vicinal epoxy groups per molecule, i.e. at least one 1,2-epoxy group per molecule. In general, the epoxy resin compound may be a saturated or unsaturated aliphatic, cycloaliphatic, aromatic or heterocyclic compound which possesses at least one 1,2-epoxy group. Such compound can be substituted, if desired, with one or more non-interfering substituents, such as halogen atoms, hydroxy groups, ether radicals, lower alkyls and the like. The epoxy functional compound may include epoxy silicones, epoxy silanes and epoxy silane oligomers.

The epoxy resins may include, for example, the glycidyl polyethers of polyhydric phenols and polyhydric alcohols. As an illustration of the present invention, examples of known epoxy resins that may be used in the present invention, include for example, the diglycidyl ethers of resorcinol, catechol, hydroquinone, bisphenol, bisphenol A, bisphenol AP (1,1-bis(4-hydroxylphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, dicyclopentadiene-substituted phenol resins tetramethylbiphenol, tetramethyl-tetrabromobiphenol, tetramethyltribromobiphenol, tetrachlorobisphenol A; and any combination thereof. The epoxy resins may include triglycidyl of para-aminophenol, such as Araldite MY 0510. The epoxy resins may include epoxidized tallow oils, or other naturally derived oily materials.

The epoxy resins may also include epoxy resins prepared either by reaction of diglycidyl ethers of dihydric phenols with dihydric phenols or by reaction of dihydric phenols with epichlorohydrin (also known as “taffy resins”).

Examples of suitable epoxy resins include, but are not limited to, the diglycidyl ethers of bisphenol A; 4,4′-sulfonyldiphenol; 4,4-oxydiphenol; 4,4′-dihydroxybenzophenone; resorcinol; hydroquinone; 9,9′-bis(4-hydroxyphenyl)fluorene; 4,4′-dihydroxybiphenyl or 4,4′-dihydroxy-α-methylstilbene and the diglycidyl esters of the dicarboxylic acids mentioned previously.

The epoxy resin may include bisphenol-based epoxy, ortho-cresol novolac, multi-functional epoxy, amine-based epoxy, heterocyclic epoxy, substituted epoxy, and naphthol-based epoxy, specifically, bisphenol A epoxy resin, bisphenol F epoxy resin, hydrogenated bisphenol type epoxy resin, alicyclic epoxy resin, aromatic epoxy resin, novolac, dicyclopentadiene type epoxy resin, and a combination thereof. Examples of suitable epoxy resins include, but are not limited to, a bisphenol-based epoxy resin such as EPICLON 830-S, EPICLON EXA-830CRP, EPICLON EXA 850-S, EPICLON EXA-850CRP, and EPICLON EXA-835LY (Dainippon Ink & Chemicals Inc.); EPIKOTE 807, EPIKOTE 815, EPIKOTE 825, EPIKOTE827 EPIKOTE 828, EPIKOTE 834, EPIKOTE 1001, EPIKOTE 1004, EPIKOTE 1007, and EPIKOTE 1009 (Yuka Shell Epoxy Co.) DER-330, DER-301, DER-361 (DOW Chemical Company), YD-128, YDF-170, and the like (KUKDO CHEMICAL CO. LTD.); an ortho-cresol novolac-based epoxy resin such as YDCN-500-1P, YDCN-500-4P, YDCN-500-5P, YDCN-500-7P, YDCN-500-80P, YDCN-500-90P (KUKDO CHEMICAL CO. LTD.), EOCN-102S, EOCN-103S, EOCN-104S, EOCN-1012, EOCN-1025, EOCN-1027, and the like (Nippon Kayaku Co. Ltd.); a multi-functional epoxy resin such as Epon 1031 S (Yuka Shell Epoxy Co.), ALALDITE 0163 (Ciba Specialty Chemicals Corp.), DENACOL EX-611, DENACOL EX-614, DENACOL EX-614B, DENACOL EX-622, DENACOL EX-512, DENACOL EX-521, DENACOL EX-421, DENACOL EX-411, DENACOL EX-321, and the like (Nagase ChemteX Corporation); an amine-based epoxy resin such as EPIKOTE 604 (Yuka Shell Epoxy Co.), YH-434 (KUKDO CHEMICAL CO. LTD.), TETRAD-X, TETRAD-C (Mitsubishi Gas Chemical Company, Inc.), ELM-120 (Sumitomo Chemical Co., Ltd.), and the like, a heterocyclic epoxy resin such as PT-810 (Ciba Specialty Chemicals Corp.); a substituted epoxy resin such as ERL-4234, ERL-4299, ERL-4221, ERL-4206 (Union Carbide Corp.) and a naphthol-based epoxy resin such as EPICLON HP-4032, EPICLON HP-4032D, EPICLON HP-4700, EPICLON 4701 (Dainippon Ink & Chemicals Inc.). These may be used singularly or as a mixture of two or more. To obtain excellent film coating characteristic, a phenoxy resin may be applied, and a high molecular weight resin such as EPIKOTE 1256 (Japan Epoxy Resins Co., Ltd.) and PKHH (InChem Co.), YP-70 (KUKDO CHEMICAL CO. LTD.), and the like may be applied. Epoxy resin derived from tall oil may include Altamer E125 from Ingevity.

Epoxy resin may include epoxy resin derived from wood pulp, wood waste, or other vegetal waste.

The epoxy resin can be present in an amount of from about 3 wt. % to about 45 wt. %, from about 5 wt. % to about 40 wt. %, or from about 10 wt. % to about 35 wt. % based on the total weight of the composition.

In embodiments, the ratio of amine active hydrogen to epoxy is from about 0.3 to less than 0.8, from about 0.3 to about 0.75, or from about 0.5 to about 0.7.

The molar ratio of amine active hydrogen to epoxy groups is calculated using the amine hydrogen equivalent weight (AHEW) values of the amine functional compounds and the epoxide equivalent weight (EEW) values of the epoxy functional compounds. The total moles of amine active hydrogen (AHM) are calculated by taking the sum of the weight of each amine functional compound divided by the amine functional compound's AHEW. The total moles of epoxy (EM) are calculated by taking the sum of the weight of each epoxy functional compound divided its EEW. The molar ratio of amine active hydrogen to epoxy groups are calculated by taking the ratio of AHM to EM.

The amine functional compounds and the epoxy functional compounds are provided such that the ratio of AHM to EM is from about 0.3 to less than 0.8. In embodiments, the AHM to EM ratio is from about 0.3 to about 0.75, from about 0.4 to about 0.7, or from about 0.5 to about 0.6. By controlling the AHM to EM ratio within this range, excellent adhesive properties and strength properties for the adhesive can be obtained.

Catalysts typically used in the formation of the adhesive may be selected as desired for an intended purpose or application. Examples of suitable catalysts include, but are not limited to, organotin compounds and tertiary amines. Other suitable non-limiting examples of catalysts used for curing the adhesive are well known in the art and include chelates of various metals such as those which can be obtained from acetylacetone, benzoylacetone, trifluoroacetylacetone, ethyl acetoacetate, salicylaldehyde, cyclopentanone-2-carboxylate, acetylacetoneimine, bis-acetylaceone-alkylenediimines, salicylaldehydeimine, and the like, with the various metals such as Al, Be, Mg, K, Zn, Cd, Pb, Ti, Zr, Sn, As, Bi, Cr, Mo, Mn, Fe, Co, Ni, and metal oxide ions as MoO₂++, UO₂++, and the like; alcoholates and phenolates of various metals such as Ti(OR)₄, Sn(OR)₄, Sn(OR)₂, Al(OR)₃, Bi(OR)₃ and the like, wherein R is alkyl or aryl of from 1 to about 18 carbon atoms, and reaction products of alcoholates of various metals with carboxylic acids, beta-diketones, and 2-(N,N-dialkylamino) alkanols, such as well-known chelates of titanium obtained by this or equivalent procedures. Further catalysts include organometallic derivatives of tetravalent tin, trivalent and pentavalent As, Sb, and Bi, and metal carbonyls of iron and cobalt; and combinations thereof. In one specific embodiment organotin compounds that are dialkyltin salts of carboxylic acids, can include the non-limiting examples of dibutyltin diacetate, dibutyltin dilaurate, dibutyltin maleate, dilauryltin diacetate, dioctyltin diacetate, dibutyltin-bis(4-methylaminobenzoate), dibutyltindilaurylmercaptide, dibutyltin-bis(6-methylaminocaproate), and the like, and combinations thereof. Similarly, in another embodiment there may be used trialkyltin hydroxide, dialkyltin oxide, dialkyltin dialkoxide, or dialkyltin dichloride and combinations thereof. Non-limiting examples of these compounds include trimethyltin hydroxide, tributyltin hydroxide, trioctyltin hydroxide, dibutyltin oxide, dioctyltin oxide, dilauryltin oxide, dibutyltin-bis(isopropoxide), dibutyltin-bis(2-dimethylaminopentylate), dibutyltin dichloride, dioctyltin dichloride, and the like, and combinations thereof.

The catalyst can be present in an amount of from about 0 wt. % to about 4 wt. %, from about 0.02 wt. % to about 3 wt. % or from about 0.09 wt. % to about 1 wt. %.

The composition may optionally contain silanes other than aminosilanes. Such silanes are used as adhesion promoters in compositions. Examples of suitable non-amino silanes include, but are not limited to, epoxy silanes, isocyanatosilanes, acryloxy silanes, mercapto silanes, and the like. Some examples of particular non-amino silanes include, but are not limited to, methacryloxypropyltrimethoxysilane, gamma-glycidoxypropylethyldimethoxysilane, gamma-glycidoxypropyltrimethoxysilane, gamma-glycidoxyethyltrimethoxysilane, gamma (3,4 epoxycyclohexyl)ethlytrimethoxysilane, beta(3,4_epoxycyclohexyl)ethylmethyl diemthoxysilane, epoxylimonyltrimethoxysilane, isocyanatopropyltriethoxysilane, isocyanatopropoyltrimethoxysilane, isocyanatopropylmethyldimethoxysilane, beta-cyano-ethyl-trimethoxysilane, gamma-acryloxypropyl trimethoxy silane, gamma-methacryloxypropyl methyldimethoxysilane, 3-mercarptopropyltrimethoxysilane, 3-mercaptopropyltriethoxysilane, 3-mercaptopropyl-methyldimethoxysilane, and the like.

For practical application, the moisture-curable composition may optionally contain additives, such as pigments, fillers, curing catalysts, dyes, plasticizers, thickeners, coupling agents, extenders, volatile organic solvents, wetting agents, tackifiers, crosslinking agents, thermoplastic polymers, moisture scavengers, and/or UV stabilizers. The additives may be used in any suitable quantities familiar to a skilled person in the field as may be useful for a particular purpose or intended application.

The adhesive composition may include a filler. Suitable fillers include inorganic fillers and organic fillers. Suitable inorganic fillers include but are not limited to, ground, precipitated and colloidal calcium carbonates which is treated with compounds such as stearate or stearic acid, reinforcing silicas such as fumed silicas, precipitated silicas, silica gels and hydrophobized silicas and silica gels; crushed and ground quartz, alumina, aluminum hydroxide, aluminum trihydrate, titanium hydroxide, titanium oxide, diatomaceous earth, iron oxide, zinc sulfide, or clays such as kaolin, bentonite or montmorillonite, talc, mica, and the like.

In some embodiments, the fillers include thermally conductive fillers. Thermally conductive fillers may include but not limited to alumina, magnesia, ceria, hafnia, lanthanum oxide, neodymium oxide, samaria, praseodymium oxide, thoria, urania, yttria, zinc oxide, zirconia, silicon aluminum oxynitride, borosilicate glasses, barium titanate, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, aluminum hydroxide, magnesium hydroxide, silica, silicon dioxide, titanium dioxide, glass fibers, glass flake, clays, exfoliated clays, or other high aspect ratio fibers, rods, or flakes, calcium carbonate, zinc oxide, magnesia, titania, calcium carbonate, talc, mica, wollastonite, alumina, aluminum nitride, graphite, graphene, aluminum powder, copper powder, bronze powder, brass powder, fibers or whiskers of carbon, graphite, silicon carbide, silicon nitride, alumina, aluminum nitride, zinc oxide, carbon nanotubes, boron nitride nanosheets, zinc oxide nanotubes, or a combination of two or more thereof. In an embodiment, the thermally conductive fillers have average particles sizes from 20 nanometers to 100 microns, from about 50 nanometers to about 50 microns, from about 100 nanometers to about 25 microns, or from about 500 nanometers to about 10 microns. The average particle size is measured by dynamic light scattering or image analysis techniques. In an embodiment of the present invention, treated calcium carbonates have particle sizes from about 0.07 micrometers (m) to about 4 micrometers (m) and are available from several companies under several trade names Ultra Pflex, Super Pflex, Hi Pflex from Specialty Minerals; Winnofil SPM, SPT from Zeneca Resins; Hubercarb 1Qt, Hubercarb 3Qt and Hubercarb W Martoxid, Magnifin, Martinal from Huber and Kotomite from ECC. Fillers commonly used in Japan include Hakuenka CCR, Hakuenka CC from Shiraishi Kogyo; Calfine 200 from Maruo Calcium. These fillers can be used either alone or in combination.

Organic fillers include carbon-blacks, char, soot, graphene, graphite, carbon nanotubes, carbon nanofibers, cellulose nanocrystals. To further improve the physical strength of the curable resin-forming composition, reinforcing carbon black can be used as a main filler, leading to black systems. Several commercial grades of carbon black useful in this invention are available, such as, but not limited to, “Corax” products (Degussa), ELFTEX® products (Cabot). To obtain translucent formulations, higher levels of fumed silica or precipitated silica can be used as the main filler, without carbon black.

The fillers can be used either alone or in combination. The fillers can be present in the composition in an amount of from about 3 wt. % to about 90 wt. %, from about 5 wt. % to about 80 wt. %, or from about 10 wt. % to about 50 wt. % based on the total weight of the composition.

In embodiments, the compositions may include a plasticizer. The plasticizer is not particularly limited and can be selected from any material suitable as a plasticizer. Examples of suitable plasticizers include, but are not limited to, carboxylic esters such as phthalates, especially dioctyl phthalate, bis(2-ethylhexyl) phthalate, bis(3-propylheptyl) phthalate, diisononyl phthalate or diisodecyl phthalate, diesters of ortho-cyclohexane-dicarboxylic acid, especially diisononyl 1,2-cyclohexanedicarboxylate, adipates, especially dioctyl adipate, bis(2-ethylhexyl) adipate, azelates, especially bis(2-ethylhexyl) azelate, sebacates, especially bis(2-ethylhexyl) sebacate or diisononyl sebacate, glycol ethers, glycol esters, organic phosphoric or sulfonic esters, sulfonamides, polybutenes, or fatty acid methyl or ethyl esters derived from natural fats or oils, also called “biodiesel”.

Other suitable plasticizers include, for example, polymeric plasticizers, which refer to a polymeric additive that is a liquid at room temperature and does not include a hydrolyzable silane. Examples of suitable olymeric plasticizers include, but are not limited to, polyols such as polyether polyols, polyester polyols, polyhydorcarbaon polyols, polybutadiene polyols, poly(meth)acrylate polyols, and the like.

Still other examples of suitable plasticizer materials include, for example, tiralkyl and/or triaryl phospates. Examples of suitable phosphate based plasticizers include, but are not limited to, triethyl phosphate, tricresyl phosphate, triphenyl phosphate, diphenyl cresyl phosphate, isodecyl diphenyl phosphate, tris(1,3-dichloro-2-propyl) phosphate, tris(2-chloroethyl) phosphate, tris(2-ethylhexyl) phosphate, tris(chloroisopropyl) phosphate, tris(chloropropyl) phosphate, isopropylated triphenyl phosphate, mono-, bis- or tris(isopropylphenyl) phosphates. Examples of trialkyl and/or triaryl phosphate plasticizers include tris-(2-ethylhexyl)-phosphate (sold under the trade name Disflamoll® TOF by Lanxess), cresyl diphenyl phosphate, tricresyl phosphate, and triphenyl phosphate (all sold under the trade name range Disflamoll© by Lanxess). Trialkyl and/or triaryl phosphate plasticizers may also contribute to imparting flame-retardant properties to the composition.

In embodiments, the composition includes a moisture scavenger. Examples of moisture scavengers include, but are not limited to, vinyltrimethoxysilane, methyltrimethoxysilane, hexamethyldisilazane, paratoluene sulfonyl isocyanate (PTSI), toluene diisocyanate (TDI), diphenyl methane diisocyanate (MDI), and polymeric MDL and the like. An example of a suitable moisture scavenger is, but is not limited to, Silquest® A-171 available from Momentive Performance Materials Inc.

The composition may be provided as a two-part composition. In embodiments, the first part, which may sometimes be referred to herein as Part A, includes the silylated polyurethane, the amine functional compound, and optionally the filler. The second part, which may be referred to herein as Part B, may include the epoxy functional material and the catalyst. In another embodiment, the first part includes the silylated polyurethane, the epoxy functional material, the catalyst, the aminosilane and optionally the filler. The second part, may include the amino functional compounds, the water and optionally the filler.

The compositions can be cured by a dual cure mechanism involving an initial condensation curing reaction followed by heating the mixture. The condensation curing step includes combining the silylated polyurethane, the amine functional compounds, the epoxy functional compounds, catalyst and optionally the fillers—and exposing the mixture to moisture. The mixture can contain some water and the mixture may also be cured upon exposure to moisture in the atmosphere at room temperature (e.g., about 20° C. to 25° C.) for a period of from about 1 to about 24 hours. After curing for a selected period of time, the mixture is heated at a temperature of from about 50° C. to about 130° C. Alternatively, the compositions can be cured by performing the heating step first by combining under shear the silylated polyurethane, the epoxy functional compounds and the amine functional compounds, while maintaining the mixture in anhydrous condition. In a second step, the water and catalyst can be added to perform the condensation cure.

The compositions can be employed to bond substrates together. The composition exhibits excellent bonding across a variety of substrates, and thus the substrates can be of the same or different materials. Substrates can be selected from a variety of materials including, but not limited to, metals and metal alloys, thermoplastics, thermosets, glass, ceramics, carbonaceous materials (e.g., a carbon fiber reinforced composite), cements, stone, wood, cellulosics, composites and laminates of the foregoing, etc. Examples of substrates include, but are not limited to, polyesters, polycarbonates, polyurethanes, polypropylenes, polyamides, polyvinyl chloride, polyolefin, polyvinyl acetate, polyether ether ketone, aluminum, aluminized plastics, and the like. The substrates can be formed from the same or different material, possess the same or different mechanical properties, have the same or different structural characteristics, dimensions, etc.

In one embodiment, the compositions are capable of adhering to a substrate and/or adhering two substrates together without the use of a primer material, and preferably without the use of an isocyanate-based primer.

A bonded material employing the adhesives may have, in embodiments, a shear strength of 3 MPa or greater, 4 MPa or greater, 5 MPa or greater, or 6 MPa or greater as measured using ASTM D1002. In embodiments, the bonded material has a shear strength of from 3 MPa to 9 MPa, from 3.5 MPa to 8 MPa, from 4 MPa to 7 MPa, or from 5 MPa to 6 MPa.

In one embodiment, a bonded material employing the adhesives may have, in embodiments, a shear strength of 4 MPa or greater, MPa or greater, or 6 MPa or greater, 8 MPa or greater, 10 MPa or greater, 12 MPa or greater, or 14 MPa or greater as measured using ASTM D1002 after curing for 24 hours at 50° C. followed by immersion in 50° C. water for one week. In embodiments, the bonded material has a shear strength of from 4 MPa to 18 MPa, from 6 MPa to 16 MPa, from 8 MPa to 14 MPa, or from 10 MPa to 12 MPa as measured using ASTM D1002 after curing for 24 hours at 50° C. followed by immersion in 50° C. water for one week.

The bonded material delaminates, in embodiments, cohesively as evaluated using ASTM D1002. In embodiments, the bonded material delaminates cohesively as evaluated using ASTM D1002 after curing for 24 hours at 50° C. followed by immersion in 50° C. water for one week.

In one embodiment, the adhesive composition can be applied to a surface of a substrate and brought into contact with a surface of another substrate. The composition can undergo the initial condensation curing for a period of from about 1 to about 24 hours, and then the assembly can be heated to effect the final curing.

### Examples

### Preparation of Adhesive Compositions

Part A of the adhesive composition contained the silylated polyurethane resin SPUR+1050 or SPUR+1070, the amine hardeners Jeffamine D230 and Jeffamine T403, the aminosilane Silquest 1120J, and the carbon black filler Eltex 8. Part A was prepared by mixing the ingredients.

Part B of the adhesive composition contained the bisphenol A resin, the Tin catalyst and water.

The amount of amine functional compounds in part A and epoxy resin in part B was such that the molar ratio of amine active hydrogen to epoxy AHM/EM was less than 0.8 and more than 0.3.

Part A and Part B were mixed before use for the bonding process.

### Bonding Process

The adhesive was applied to an area of an aluminum, or PET plastic substrate (1″×3″) or carbon reinforced composite. Two wire copper spacers of 0.5 mm diameter were placed on the adhesive layer. Another substrate (1″×3″) was placed on top of the first substrate to form a lapshear sample. The bonding area was rectangular 0.5″×1″. Clamps were used to hold the two substrates together during curing step. The bonding sample was then cured.

### Curing

For the curing step, the lap shear sample was placed in an oven immediately after the adhesive bond preparation or was placed at room temperature for a period of time before being placed in an oven. The time before the heating step varied from 1 hour to 24 hours. The temperature of the oven varied from 50° C. or 130° C. The time of the heating step varied depending of the oven temperature (from several min to several days).

### Bonding Strength Evaluation

After the heating step, the bonded sample (lap shear or others) was cooled and tested for strength, by applying force to break the bond and measuring the bond strength (ASTM D1002). In addition, the failure mode after bond breakage was assessed. A cohesive failure mode means that the sample failed within the adhesive itself and that after the bond fails, there was a visible layer of adhesive on both substrates. An adhesive failure mode means that the sample failed at the interface with the substrate, leaving one of the substrates with no visible residue of adhesive.

### Adhesion to Aluminum

Adhesive compositions were prepared according to the compositions of Table 1. The silylated polyurethane prepolymer, SPUR+1050 prepolymer, the aminosilane Silquest A-1120J (AHEW=74), the Tin catalyst Fomrez SUL11C were from Momentive. Jeffamine® D230 (AHEW=60) and T403 polyetheramine (AHEW=81) were from Hunstman, The carbon black filler Eltex E8 was from Cabot. The bisphenol A resin D.E.R. 330 (EEW=178) was from Olin. Part A was prepared, and Part B was prepared separately. Part A and Part B composition were mixed in a FlackTek SpeedMixer®. The adhesive composition resulting from the mixing of Part A and Part B was applied to the aluminum sample, which was AlClad AD2024T3C. The lap shear samples were cured at 50° C. for 24 hours.

TABLE 1

| | EX1 | Ex2 | Ex3 | EX4 | EX5 | Comp1 | Comp2 |
|---|---|---|---|---|---|---|---|
| Part A | | | | | | | |
| SPUR + 1050 prepolymer (part) | 100 | 100 | 100 | 100 | 100 | 100 | 100 |
| Silquest A-1120J aminosilane (part) | 3 | 3 | 3 | 3 | 3 | 3 | 3 |
| Jeffamine D230 polyetheramine (part) | 2.7 | 5.6 | 7.2 | 8.6 | 7.2 | 10 | 13 |
| Jeffamine T403 polyetheramine (part) | 1.3 | 2.8 | 3.6 | 4.3 | 3.6 | 5 | 6.5 |
| Eltex E8 carbon black (part) | 33 | 34 | 34 | 35 | 13 | 35 | 36 |
| Part B | | | | | | | |
| DER 330 epoxy resin (part) | 60 | 60 | 60 | 60 | 60 | 60 | 60 |
| Fomrez SUL11C (part) | 0.26 | 0.26 | 0.26 | 0.26 | 0.26 | 0.26 | 0.26 |
| Water (part) | 1 | 1 | 1 | 1 | 1 | 1 | 1 |
| amine active hydrogen/epoxy molar ratio | 0.3 | 0.5 | 0.6 | 0.7 | 0.61 | 0.8 | 1 |
| Adhesion on Aluminum | | | | | | | |
| Failure mode (Aluminum) | CF | CF | CF | CF | CF | AF | AF |
| Shear strength (Mpa) | 3.3 | 5.9 | 7.2 | 7.4 | 6.5 | 7.3 | 5.7 |

As shown in Table 1, the shear strength on aluminum for Examples 1-5 is higher than 3 MPa and cohesive failure (CF), which is an exemplary mode of failure, was obtained when the ratio AHM/EM was smaller than 0.8. In contrast, Comparative Examples 1 and 2 displayed adhesive failure mode indicating undesirable adhesion.

### Adhesion on PET

Adhesion to a polyethylene terephthalate (PET) was examined using the compositions set forth in Table 2. Adhesive compositions shown in Table 2 were prepared as in EXAMPLE A. The lapshear samples were cured at 50° C. for 24 hours.

TABLE 2

| | Ex6 | Ex7 | Comp Ex 3 |
|---|---|---|---|
| Part A | | | |
| SPUR + 1050 prepolymer | 100 | 100 | 100 |
| Silquest A-1120J aminosilane | 3 | | |
| Silquest A-1110 aminosilane | | 6.1 | |
| Jeffamine D-230 polyetheramine | 7.2 | 6 | 9 |
| Jeffamine T403 polyetheramine | 3.6 | 3 | 4.5 |
| Eltex 8 Carbon Black | 34 | 34 | 34 |
| Part B | | | |
| DER 330-epoxy resin | 60 | 60 | 60 |
| Fomrez SUL-11C Tin catalyst | 0.26 | 0.26 | 0.26 |
| Water | 1 | 1 | 1 |
| amine active hydrogen/epoxy | 0.61 | 0.61 | 0.61 |
| molar ratio | | | |
| Adhesion on PET substrate | | | |
| Failure mode | CF | CF | AF |
| Shear strength (Mpa) | 5.8 | 4.8 | 1.4 |

Examples 6 and 7 had a shear strength on PET substrate that is higher than 4 MPa and exhibited cohesive failure. Comparative example (Comp Ex) 3, which did not include the aminosilane, displayed adhesive failure mode indicating undesirable adhesion.

### Adhesion on Carbon Fiber Reinforced Composite (CFRC)

Substrates were made of carbon fiber reinforced composite and provided by the Institute of Science and Innovation in Mechanical and Industrial Engineering (University of Porto). The silylated polyurethane SPUR+1070 was obtained from Momentive. Adhesive compositions were prepared in a manner similar to Example A. The lap shear samples were cured at 50° C. for 24 hours. The properties in adhering to the composite are shown in Table 3.

TABLE 3

| | Ex 8 |
|---|---|
| SPUR + 1070 prepolymer | 100 |
| Silquest A-1120J aminosilane | 3 |
| Jeffamine D230 polyetheramine | 7.2 |
| Jeffamine T403 polyetheramine | 3.6 |
| Eltex E8 carbon black | 34 |
| DER 330 epoxy resin | 60 |
| Altamer 125 | |
| Fomrez SUL11C | 0.26 |
| Water | 1 |
| amine active hydrogen/epoxy | 0.6 |
| molar ratio | |
| Adhesion on CFRC substrate | |
| Failure mode (Aluminum) | CF |
| Shear strength (Mpa) | 5.2 |

The composition had a shear strength greater than 4 MPa and exhibited cohesive failure.

### Adhesion to Aluminum

A composition was prepared according to Table 4.

TABLE 4

| | Ex 9 |
|---|---|
| Part A | |
| SPUR + 1050 Prepolymer | 100 |
| Silquest A-1120J | 3 |
| Jeffamine D-230 polyetheramine | 6.4 |
| Jeffamine T-403 polyetheramine | 3.2 |
| Carbon Black | 41.5 |
| Part B | |
| DER 330 Epoxy resin | 25 |
| Altamer E125 Epoxy resin | 75 |
| Fomrez SUL-11C Tin catalyst | 0.26 |
| Water | 1 |
| amine active hydrogen/epoxy molar ratio | 0.700 |
| Shear strength on Aluminum (MPa) | 4.856 |
| Failure Mode | CF |

AltaMer EP 125 is a distilled tall oil epoxy oligomer. The composition exhibited excellent adhesion to aluminum (greater than 4 Mpa) and also exhibited cohesive failure.

### Adhesion on Dissimilar Substrates:

The composition of the adhesive shown in Example 8 was applied to an area of an aluminum substrate (Alclad AD2024T3C). Another substrate of PET plastic or acrylic plastic was placed on top of the first aluminum substrate to form a bonding lap shear sample of dissimilar. materials. The lap shear samples were cured at 50° C. for 24 hours.

The shear strengths of the dissimilar material lap shear samples are shown in Table 5.

TABLE 5
Shear strengths of dissimilar material lap shear samples

| | Ex 10 | Ex 11 |
|---|---|---|
| | Aluminum/ | Aluminum/ |
| | Acrylic | PET |
| Shear strength | 5.69 | 6.17 |
| (MPa) | | |
| Failure mode | CF | CF (SF - Plastic |
| | | Broke) |

The bond of dissimilar materials exhibited shear strength greater than 4 MPa.

Wet adhesion: The adhesion strength on various wet substrates was also evaluated and is described in the following examples.

### Wet Adhesion on Polyproplyene Substrate

A polypropylene substrate was treated with corona for 20 second with a Tantec Labtec instrument. Adhesion to the corona treated polypropylene substrate was examined using the compositions set forth in Table 6. Adhesive compositions shown in Table 6 were prepared as described above for the previous examples. The lapshear samples were cured at 50° C. for 24 hours, then immersed in 50° C. water for one week. The lapshear strength was measured immediately after immersion. The lap shear strength was observed as 4.8 MPa. A comparative composition having a AHM/EM ratio greater than 0.8 showed significantly lower lap shear strength.

TABLE 6
Wet adhesion on polypropylene

| | Ex 12 (phr) |
|---|---|
| Part A | |
| SPUR + 1070 prepolymer | 100 |
| Silquest A-1120J | 3 |
| Jeffamine D-230 polyetheramine | 7.2 |
| Jeffamine T-403 polyetheramine | 3.6 |
| Carbon black | 34.1 |
| Part B | |
| DER 330 Epoxy resin | 60 |
| TIB KAT 424 Tin catalyst | 0.26 |
| Water | 1 |
| Sum | 209.16 |
| amine active hydrogen/epoxy molar ratio | 0.608 |
| Wet adhesion on corona treated polypropylene | |
| Failure Mode | CF |
| Shear Strength (MPa) | 4.8 |

### Wet Adhesion on Aluminum

Adhesion to aluminum substrate was examined using the compositions set forth in Table 7. Adhesive compositions shown in Table 7 were prepared as described above for the previous examples. The lapshear samples were cured at 50° C. for 24 hours, then immersed in 50° C. water for one week. The lap shear strength was measured immediately after immersion. The lap shear strength was observed as 14.2 MPa. A comparative example having a AHM/EM ratio greater than 0.8 showed significantly lower lap shear strength.

TABLE 7
Wet adhesion on aluminum

| | Ex 13 (phr) |
|---|---|
| Part A | |
| SPUR + 1070 prepolymer | 100 |
| Silquest A-1120J | 3 |
| Jeffamine D-230 polyetheramine | 7.2 |
| Jeffamine T-403 polyetheramine | 3.6 |
| Carbon black | 34.1 |
| Part B | |
| DER 330 Epoxy resin | 60 |
| TIB KAT 424 Tin catalyst | 0.26 |
| Water | 1 |
| Sum | 209.16 |
| amine active hydrogen/epoxy molar ratio | 0.608 |
| Wet adhesion on aluminum | |
| Failure Mode | CF |
| Shear Strength (MPa) | 14.2 |

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of an adhesive composition. Modifications may occur to those skilled in the art and to those who may make and use the invention. The disclosed embodiments are merely for illustrative purposes and not intended to limit the scope of the invention or the subject matter set forth in the claims.

What is claimed is:

1. A composition comprising:
a silylated polyurethane;
an amine functional compound; and
an epoxy functional compound;
wherein the composition has a molar ratio of amine active hydrogen to epoxy of in a range from about 0.3 to less than 0.8.

2. The composition of claim 1, wherein the composition has a molar ratio of amine active hydrogen to epoxy from about 0.3 to about 0.75.

3. The composition of claim 1, wherein the composition has a molar ratio of amine active hydrogen to epoxy of in a range from about 0.4 to about 0.7.

4. The composition of claim 1, wherein the composition has a molar ratio of amine active hydrogen to epoxy of from about 0.5 to about 0.6.

5. The composition of claim 1, wherein the amine functional compound is selected from a polyether amine, an amino silane, or a combination thereof.

6. The composition of claim 5, wherein the polyether amine has a weight average molecular weight of from about 150 to about 6000.

7. The composition of claim 5, wherein the composition comprises the polyether amine in an amount of from about 0.1 wt. % to about 10 wt. %, and the amino silane in an amount of from about 0.1 wt. % to about 10 wt. % based on the total weight of the composition.

8. The composition of claim 5, wherein the amino silane is selected from a compound of the formula:
(R¹¹)(R¹²)N—R¹³—Si(OR¹⁴)₃₋ₕ(R¹⁵)ₕ;
R¹⁶—NH—R¹⁷—Si(OR¹⁸)₃₋ᵢ(R¹⁹)i;
(R²⁰)ⱼ(R²¹O)₃₋ⱼSi—R²²—NH—R²³—Si(OR²⁴)₃₋ₖ(R²⁵)k;
N—(R²⁶—Si(OR²⁷)₃₋ₘ(R²⁸m)₃;
where R¹¹, R¹², and R¹⁶ are independently selected from H or a monovalent C1-C20 hydrocarbon;
R¹⁴, R¹⁵, R¹⁸, R¹⁹, R²⁰, R²¹, R²⁴, R²⁵, R²⁷, and R²⁸ are independently selected from a C1-C20 monovalent hydrocarbon; R¹³, R¹⁷, R²², and R²⁶ are independently selected from a divalent C1-C20 hydrocarbon; h, i, j, k, and m are independently selected from 0-2.

9. The composition of claim 1, further comprising additive selected from pigments, fillers, curing catalysts, dyes, plasticizers, thickeners, coupling agents, extenders, volatile organic solvents, wetting agents, tackifiers, crosslinking agents, thermoplastic polymers, moisture scavengers, and UV stabilizers.

10. The composition of claim 9, wherein the catalyst is a Tin catalyst.

11. The composition of claim 9, wherein the filler is selected from organic fillers, inorganic fillers, conductive fillers, or combinations thereof.

12. The composition of claim 11, wherein the conductive filler is a thermally conductive filler selected from alumina, magnesia, ceria, hafnia, lanthanum oxide, neodymium oxide, samaria, praseodymium oxide, thoria, urania, yttria, zinc oxide, zirconia, silicon aluminum oxynitride, borosilicate glasses, barium titanate, silicon carbide, silica, boron carbide, titanium carbide, zirconium carbide, boron nitride, silicon nitride, aluminum nitride, titanium nitride, zirconium nitride, zirconium boride, titanium diboride, aluminum dodecaboride, barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, aluminum hydroxide, magnesium hydroxide, silica, silicon dioxide, titanium dioxide, glass fibers, glass flake, clays, exfoliated clays, or other high aspect ratio fibers, rods, or flakes, calcium carbonate, zinc oxide, magnesia, titania, calcium carbonate, talc, mica, wollastonite, alumina, aluminum nitride, graphite, graphene, aluminum powder, copper powder, bronze powder, brass powder, fibers or whiskers of carbon, graphite, silicon carbide, silicon nitride, alumina, aluminum nitride, zinc oxide, carbon nanotubes, boron nitride nanosheets, zinc oxide nanotubes, or a combination of two or more thereof.

13. A composition comprising a first part and a second part, wherein the first part comprises (i) a silylated polyurethane and an amino functional compound, and the second part comprises (ii) an epoxy functional compound.

14. A method of forming an adhesive comprising: (i) exposing the composition of any of claim 1 to moisture; and subsequently (ii) curing the composition to a temperature of from about 50° C. to about 130° C.

15. The method of claim 14, wherein the adhesive is formed on a substrate.

16. A method of bonding two substrates comprising:
applying the composition of claim 1 on a first substrate;
contacting a second substrate with the composition applied on the first substrate; and
curing the composition at a temperature of from about 50° C. to about 130° C.

17. The method of claim 16, wherein the first and second substrate are each independently of a type selected from a metal, a thermoplastic, a thermoset, a glass, a carbon substrate, a ceramic, cement, and wood.

18. The method of claim 16, wherein the first substrate and the second substrate are the same type of material.

19. The method of claim 17, wherein the first substrate is a thermoplastic substrate, and the second substrate is a metal substrate.

20. The method of claim 16, wherein the first and second substrate are each free of a primer coating.

21. An article comprising a first substrate bonded to a second substrate with an adhesive formed from the composition of claim 1.

22. The article of claim 21, wherein the first and second substrates are each independently of a type selected from a metal, a thermoplastic, a thermoset, a glass, a carbonaceous substrate, a ceramic, cement, wood, and combinations of two or more thereof.

23. The article of claim 21, wherein the first substrate and the second substrate are the same type of material.

24. The article of claim 21, wherein the first substrate is a thermoplastic substrate, and the second substrate is a metal substrate.

25. The article of claim 21, wherein the first and second substrate are each free of a primer coating.

26. The article of claim 21, wherein the article has a shear strength of about 3 MPa or greater as determined via ASTM D1002.

27. The article of claim 21, wherein the article delaminates cohesively as determined via ASTM D1002.

28. The article of claim 21, wherein the article delaminates cohesively as determined via ASTM D1002 after curing for 24 hours at 50° C. followed by immersion in 50° C. water for one week.

29. The article of any of claim 28, wherein the article has a shear strength of about 4 MPa or greater when measured after immersion in 50° C. water for one week, as determined via ASTM D1002.

30. The article of any of claim 28, wherein the article has a shear strength of about 10 MPa or greater when measured after immersion in 50° C. water for one week, as determined via ASTM D1002.
